(19) United States
(12) Patent Application Publication
(10) Pub. No.: US 2006/0145019 A1
(43) Pub. Date: Jul. 6, 2006

(54) Triangular spacecraft

(76) Inventor: John Quincy St. Clair, San Juan, PR (US)

Correspondence Address: JOHN ST. CLAIR, 52 KINGS COURT, 4A, SAN JUAN, PR, 00911, US

(21) Appl. No.: 11/017,093

(22) Filed: Dec. 20, 2004

(51) Int. Cl. B64G 1/40

(52) U.S. Cl. 244/171.5

(57) ABSTRACT

A spacecraft having a triangular hull with vertical electrostatic line charges on each corner that produce a horizontal electric field parallel to the sides of the hull. This field, interacting with a plane wave emitted by antennas on the side of the hull, generates a force per volume combining both lift and propulsion.

### BRIEF SUMMARY OF THE INVENTION

This invention is a spacecraft having a triangular hull with vertical electrostatic line charges on each corner. The line charges create a horizontal electric field that, together with a plane wave emitted by antennas on the side of the hull, generates a force per volume providing a unique combination of both lift and propulsion.

### BACKGROUND OF THE INVENTION

Referring to FIG. 1, the spacecraft has a hull in the shape of an equilateral triangle. A parabolic antenna (E) is centrally located in the bottom of the hull. An array of horizontal slot antennas is located along the side of the hull (A). Each back corner (F,G) has a corner conducting plate which is charged to a positive voltage +V. The forward corner (C) has a conducting plate charged to a negative voltage −V. A motion control hemisphere (D) is located on the bottom surface in each of the three corners.

Referring to FIG. 2, two planes (A,B) intersect at the origin O at an opening angle β. Each plane (x,y) is charged to a voltage V. The potential at point P is determined in polar coordinates {ρφ}. The Laplace equation for the potential Φ in polar coordinates is given by:

$$\frac{1}{ρ} \frac{\partial }{\partial ρ} ( ρ \frac{\partial Φ}{\partial ρ} ) + \frac{1}{{ρ}^{2}} \frac{{\partial }^{2} Φ}{\partial {ϕ}^{2}} = 0$$

Using a separation of variables solution, the potential is given as the product of two functions:
Φ(ρ,φ)=R(ρ)Ψ(φ)
which when substituted into the Laplace equation becomes:

$$\frac{ρ}{R} \frac{ⅆ}{ⅆ ρ} ( ρ \frac{ⅆ R}{ⅆ ρ} ) + \frac{1}{Ψ} \frac{{ⅆ}^{2} Ψ}{ⅆ {ϕ}^{2}} = 0$$

Since the two terns are separately functions of ρ and φ respectively, each one has to be constant with the sum of the constants equal to zero:

$$\frac{ρ}{R} \frac{ⅆ}{ⅆ ρ} ( ρ \frac{ⅆ R}{ⅆ ρ} ) = {v}^{2} \frac{1}{Ψ} \frac{{ⅆ}^{2} Ψ}{ⅆ {ϕ}^{2}} = - {v}^{2}$$

These two equations have solutions:
R(ρ)=aρ^{v+bρ}^{-v}
ψ(φ)=Acos(vφ)+Bsin(vφ)
The azimuthal angle φ is restricted to a value in the range 0≦φ≦β. The boundary condition is that the potential Φ is equal to V for any radius ρ when φ=0 and φ=β. This means that v has to be an integer value of π so that the sine function is zero:

$$sin ( v β ) = sin ( \frac{m π}{β} β ) = sin ( m π ) = 0 m = 1 , 2 …$$

which in turn means that the coefficient A of the cosine term has to be zero in the solution above. Choosing b=0 makes the general solution for the potential equal to:

$$Φ ( ρ , ϕ ) = V + {\sum }_{m = 1}^{∞} {a}_{m} {ρ}^{m π / β} sin ( m πϕ / β )$$

which shows that when the angle is zero, the sine is zero and the potential is V. If the angle is β, then there is a multiple of π such that the sine is zero again.

Because the series involves positive powers of the radius, for small enough ρ, only the first term m=1 in the series is important. Thus around ρ=0, the potential is approximately
φ(ρ,φ)≈V+a,ρ^{π/β}sin(πφ/β)

The electric field component is the negative gradient of the potential:

$${E}_{ϕ} ( ρ , ϕ ) = - \frac{1}{ρ} \frac{\partial Φ}{\partial ϕ} = - \frac{π {a}_{1}}{β} {ρ}^{( π / β ) - 1} cos ( πϕ / β )$$

The surface charge distribution σ at φ=0 and φ=β is equal to the electric field perpendicular to the surface times the permittivity of space ε₀:

$$σ ( ρ ) = {ɛ}_{0} {E}_{ϕ} ( ρ , 0 ) = - \frac{{ɛ}_{0} π {a}_{1}}{β} {ρ}^{\frac{π}{β} - 1}$$

Notice that if angle of intersection β is less than π, then the equation says that there is a very small radius to a positive power which means little charge density accumulation.

Referring to FIG. 3, the value of β, in the case of the triangular hull, is equal to 360° less 60° for a total of 300° or:

$$β = \frac{300}{180} π = \frac{5}{3} π$$

$${ρ}^{\frac{π}{\frac{5}{3} π} - 1} = \frac{1}{{ρ}^{\frac{2}{5}}}$$

which says that there is a charge density singularity to the two fifths power for small radius. Thus, the corner plates on the hull create a huge line charge density along the sharp vertical corner edge. The equation for the potential of a line charge density is given as:

$$Φ ( x , y ) = - \frac{λ}{2 {πɛ}_{0}} Ln ( {( x - {x}_{0} )}^{2} + {( y - {y}_{0} )}^{2} )$$

where λ is the charge per unit length in the vertical z-direction, and x₀ and y₀ are the location of the line charge in the xy-plane.

Referring to FIG. 4, the triangular hull (D) is plotted together with the potential contours (A) and the electric field arrows (B) created by the three corner line charges. The line charges are perpendicular to the paper. Notice that the electric field arrows are parallel crossing the center parabolic antenna (C). The electric field is also parallel to the sides (D) of the triangle.

Referring to FIG. 5, along the side of the triangle (A), an array (B) of horizontal slot antennas emit electromagnetic waves that have a vertically polarized electric E field (C). These traveling waves interact with the electric field (D) produced by the line charges on the corners of the triangle.

Using differential forms mathematics, this combination of fields is represented by the Hodge star of the differential of the wedge product of the two fields. The antenna electromagnetic field is a combination of a traveling magnetic field B_{w}, and electric field E_{w}. The stationary field E created by the line charges is perpendicular to the traveling wave.

$$* d ( E ⋀ ( {B}_{w} + {E}_{w} ⋀ dt ) ) \frac{ɛ}{c} = \frac{force}{volume}$$

where ε is the linear capacitance of space and c is the speed of light. Thus there is a force per volume around the hull.

This combination of fields produces a spacetime curvature as determined by Einstein's General Theory of Relativity. The traveling electric field has an amplitude in the vertical z-direction and travels in the x-direction
E_{w=E}_{z}cos(x−t)
The Faraday electromagnetic tensor contains all the electric and magnetic fields in all the {x,y,z} directions. The first row and first column contain the two electric fields

$${F}_{β}^{α} = \begin{matrix}t \\ x \\ y \\ z\end{matrix} \vert \begin{matrix}0 & {E}_{x} & 0 & {E}_{z} cos ( x - t ) \\ {E}_{x} & 0 & 0 & 0 \\ 0 & 0 & 0 & 0 \\ {E}_{z} cos ( x - t ) & 0 & 0 & 0\end{matrix} \vert$$

The stress exerted on spacetime occurs in the xx, yy and zz-direction as calculated from the stress-energy tensor T of gravitational physics

$$4 π {T}^{μ v} = {F}^{μ α} {F}_{α}^{μ} - \frac{1}{4} {g}^{μ v} {F}_{α β} {F}^{αβ}$$

where g is the metric tensor for Cartesian space

$${g}_{αβ} = \begin{matrix}t \\ x \\ y \\ z\end{matrix} \vert \begin{matrix}- 1 & 0 & 0 & 0 \\ 0 & 1 & 0 & 0 \\ 0 & 0 & 1 & 0 \\ 0 & 0 & 0 & 1\end{matrix} \vert$$

where the diagonal components are the coefficients of the elementary spacetime length ds squared
(ds)²=−(dt)²+(dx)²+(dy)²+(dz)²
The calculation produces three stresses T^{xx},T^{yy} and T^{zz} in their respective {x,y,z} directions.

Referring to FIG. 6, these three stresses are plotted together as a 3D vector field animated over time in nine frames. The graphs show that there is a lift force as depicted by the vertical arrows as well as a force of propulsion as shown by the interspersed horizontal arrows. With the passage of time, these vectors exchange places with each other so that the lift becomes the propulsion and vice versa, creating a wavy stress-energy field around the hull.

### SUMMARY OF THE INVENTION

This invention is a spacecraft with a triangular hull having charged flat plates on the vertical corners of the three sides. The two rear corners are charged to a potential V. The forward corner is charged to a potential −V. The 60° angle on the corner creates a line charge density singularity that produces a huge horizontal electric field pointing from the back to the front of the craft which is also parallel to the sides of the triangle. An array of horizontal slot antennas located on the sides of the triangular hull produce an electromagnetic wave with the electric field polarized in the vertical direction. This combination of fields produces a spacetime force in both the vertical and horizontal directions such that the spacecraft receives a lift force and a force of propulsion.

### A BRIEF DESCRIPTION OF THE DRAWINGS

FIG. 1. Perspective view of triangular spacecraft.

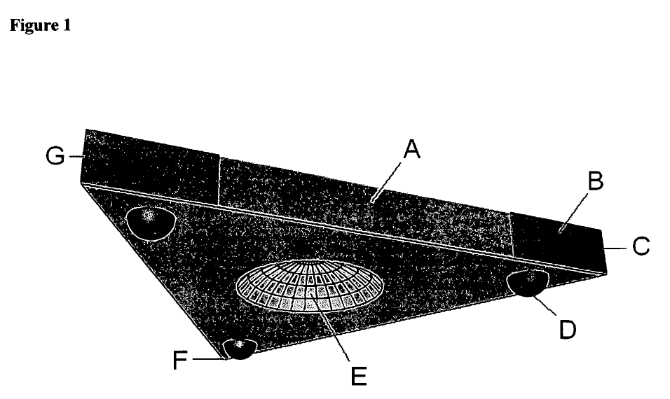

FIG. 2. Drawing of the intersection of two charged plates in order to calculate the charge density in the corner.

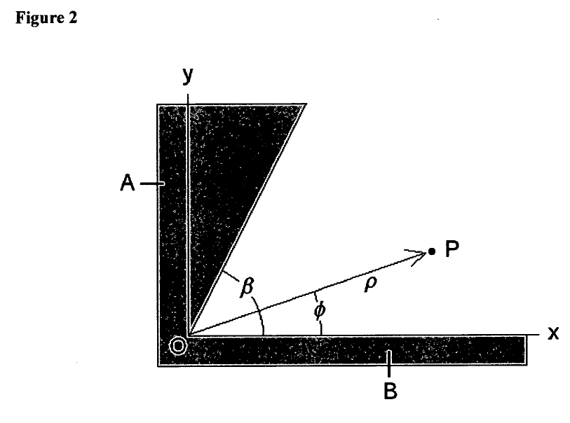

FIG. 3. Perspective view of the corner angle β for the equilateral triangle.

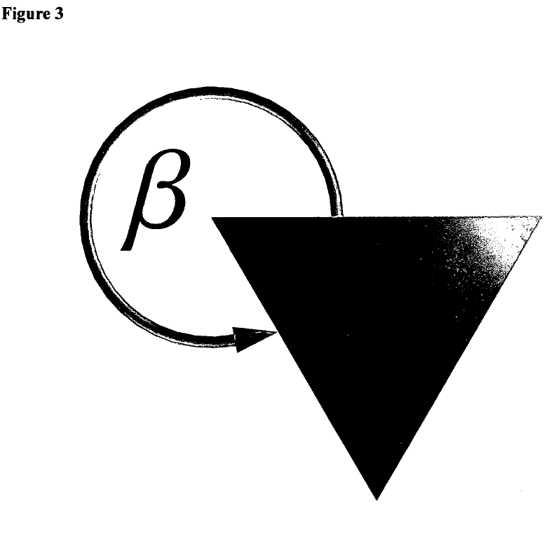

FIG. 4. Planar 2D graph showing the electric field produced by three line charges on the corners of the triangular hull.

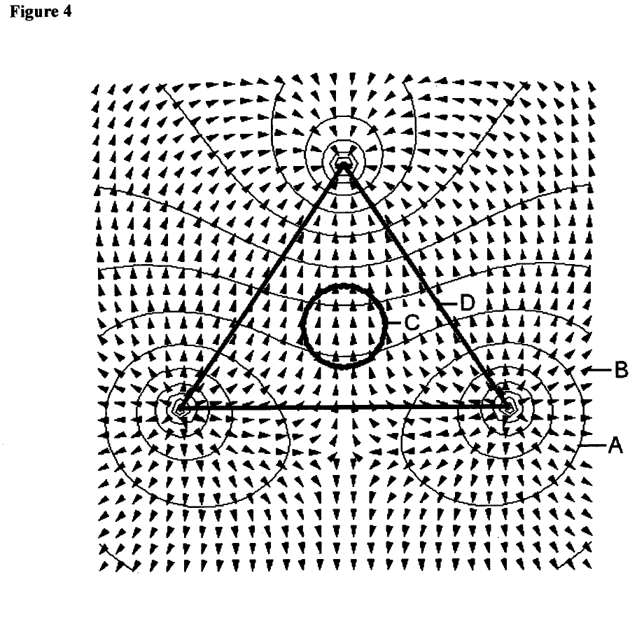

FIG. 5. Perspective view of electric field produced by the linear charge interacting with the traveling electromagnetic wave produced by the slot antenna.

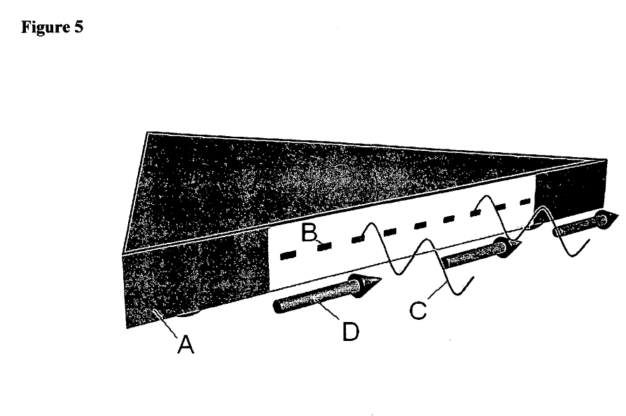

FIG. 6. 3D vector animation of the lift and thrust force generated by the fields.

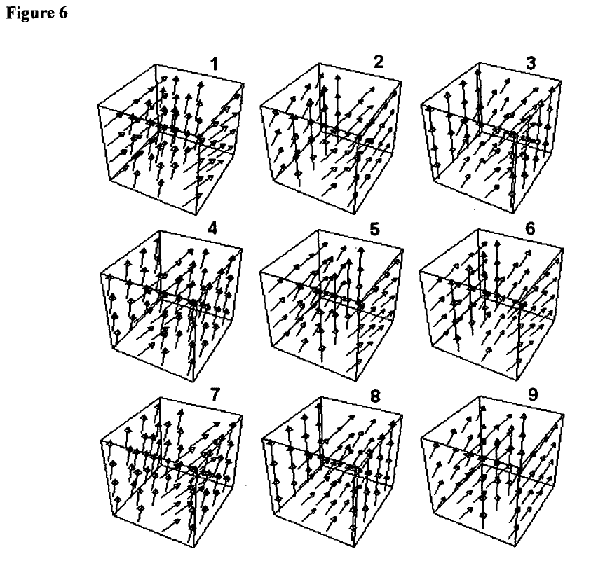

FIG. 7. Perspective view of slot antenna.

### DETAILED DESCRIPTION OF THE INVENTION

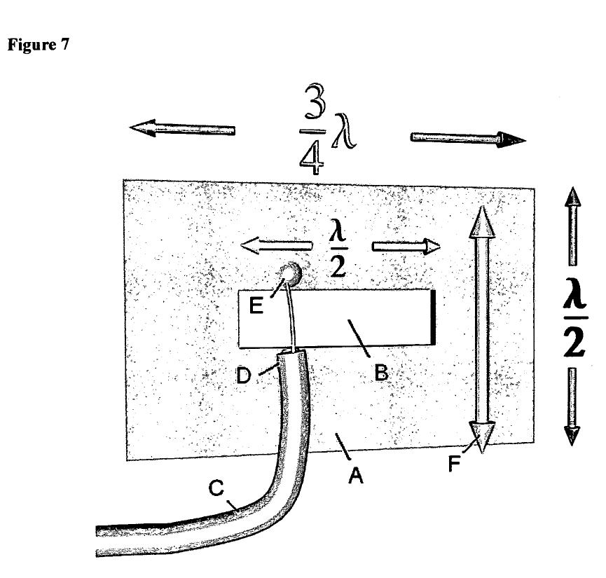

Referring to FIG. 7, the antenna (A) is made out of sheet copper in which a rectangular horizontal slot (B) has been notched out using a die press and sheet metal fixture. A coaxial cable from the amplifier and frequency generator is attached across the slot by soldering the outer cable (D) to one side of the slot and the inner cable (E) to the other side of the slot. This creates the positive and negative charges across the gap which forms the vertical electric field (F) which radiates out perpendicularly to the copper sheet.

Although the invention has been described with reference to specific embodiments, such as a particular antenna system, those skilled in the art will appreciate that many modifications and variations are possible without departing from the teachings of the invention. All such modifications and variations are intended to be encompassed within the scope of the following claims.

1. A spacecraft comprised of the following components:
(a) a triangular hull in the form of an equilateral triangle;
(b) two copper plates attached on opposite vertical sides at each of the three corners of the hull (1a) such that a sharp vertical edge is formed where they come together;
(c) an electrostatic generator used to charge the back two copper-cladded corners (1b) to a high positive voltage, and the third forward copper-cladded corner to a high negative voltage;
(d) a horizontal slot antenna array mounted-on the sides of the hull; and
(e) a frequency generator, antenna and coaxial cables to drive the antenna array (1d).

2. To create, by claims (1a, 1b, 1c), an intense vertical line charge at the corners (1b) and a horizontal electric field that that is parallel to the sides of the hull (1a);

3. To create, by claims (1d,1e), an electromagnetic wave with a vertically polarized electric field traveling outward from the side of the hull (1a); and

4. To create, by claims (2,3), an interaction of the electrostatic field (2) with the electromagnetic wave (3) such that a combined spacetime curvature pressure is generated on the hull in the upward and forward direction to produce lift and propulsion respectively.
